(19) United States
(12) Patent Application Publication
(10) Pub. No.: US 2025/0373134 A1
(43) Pub. Date: Dec. 4, 2025

(54) MOTOR

(71) Applicant: Mitsubishi Electric Corporation, Tokyo (JP)

(72) Inventors: Hiroshi MITSUDA, Chiyoda-ku, Tokyo (JP); Kazumasa ITO, Chiyoda-ku, Tokyo (JP); Tadashi FUKAMI, Nonoichi-shi, Ishikawa (JP); Masato KOYAMA, Nonoichi-shi, Ishikawa (JP)

(73) Assignee: Mitsubishi Electric Corporation, Tokyo (JP)

(21) Appl. No.: 18/873,340

(22) PCT Filed: Jun. 28, 2022
(86) PCT No.: PCT/JP2022/025727

§ 371 Date: Dec. 10, 2024

(51) Int. Cl. H02K 21/04

(52) U.S. Cl. CPC H02K 21/042

(57) ABSTRACT

A motor includes a stator and a rotor. The stator has a plurality of first teeth disposed with a spacing therebetween in a circumferential direction, and an armature winding wound around each of the plurality of first teeth. The armature winding is a ring connection. A DC power source is connected to one end and another end of the ring connection. In each of the plurality of first teeth, a magnetic pole with an identical polarity is formed by a direct current flowing through the armature winding. The rotor has a rotor core and a plurality of permanent magnets. The rotor core has an outer diameter surface facing outward in a radial direction, and an inner diameter surface which is a surface opposite to the outer diameter surface in the radial direction. The rotor core has a plurality of salient poles forming first magnetic poles in the outer diameter surface.

### TECHNICAL FIELD

The present disclosure relates to a motor.

### BACKGROUND ART

For example, Japanese Patent Laying-Open No. 2012-110213 (PTL 1) describes a motor. The motor described in PTL 1 is a consequent pole motor. The consequent pole motor has a rotor in which a first magnetic pole constituted by a permanent magnet and a second magnetic pole constituted by a portion of a rotor core are disposed alternately along a circumferential direction. Since the motor described in PTL 1 can reduce the number of permanent magnets by half, it is advantageous from the viewpoint of reducing cost and avoiding resource risk. However, the motor described in PTL 1 is disadvantageous when it performs constant output operation, because a field magnetic flux is maintained substantially constant by characteristics of the permanent magnets.

For example, Japanese Patent Laying-Open No. 2007-252071 (PTL 2) describes a motor. The motor described in PTL 2 is also a consequent pole motor. In the motor described in PTL 2, a rotor has a field winding. Thereby, unlike the motor described in PTL 1, the motor described in PTL 2 can adjust a field amount as appropriate according to an operating point to operate the motor.

### CITATION LIST

### Patent Literature

PTL 1: Japanese Patent Laying-Open No. 2012-110213
PTL 2: Japanese Patent Laying˜Open No. 2007-252071

### SUMMARY OF INVENTION

### Technical Problem

However, since the motor described in PTL 2 requires a field winding, it has a complicated structure, which leads to reduced productivity. The present disclosure has been made in view of the problems of conventional techniques as described above. More specifically, the present disclosure provides a motor that can expand an operable range by adjusting a field magnetic flux without using a field winding.

### Solution to Problem

A motor in the present disclosure includes a stator and a rotor. The stator has a plurality of first teeth disposed with a spacing therebetween in a circumferential direction, and an armature winding wound around each of the plurality of first teeth. The armature winding is a ring connection. A direct current (DC) power source is connected to one end and another end of the ring connection. In each of the plurality of first teeth, a magnetic pole with an identical polarity is formed by a direct current flowing through the armature winding. The rotor has a rotor core and a plurality of permanent magnets. The rotor core has an outer diameter surface facing outward in a radial direction, and an inner diameter surface which is a surface opposite to the outer diameter surface in the radial direction. The rotor core has a plurality of salient poles forming first magnetic poles in the outer diameter surface. The plurality of salient poles are arranged with a spacing therebetween along the circumferential direction. Each of the plurality of permanent magnets is attached to the outer diameter surface so as to be located between two adjacent salient poles of the plurality of salient poles in the circumferential direction, and forms a second magnetic pole. The plurality of salient poles and the plurality of permanent magnets face the stator, with a cavity being interposed therebetween, in the radial direction.

### Advantageous Effects of Invention

According to the motor in the present disclosure, it is possible to expand an operable range by adjusting a field magnetic flux without using a field winding.

### BRIEF DESCRIPTION OF DRAWINGS

FIG. 1 is a cross sectional view of a motor 100.

FIG. 2 is a cross sectional view taken along II-II in FIG. 1.

FIG. 3 is a schematic circuit diagram of motor 100.

FIG. 4 is a cross sectional view of a motor 100A.

FIG. 5 is a schematic circuit diagram of a motor 100B.

FIG. 6 is a cross sectional view showing one example of a rotor 20 in a motor 100C.

FIG. 7 is a cross sectional view showing another example of rotor 20 in motor 100C.

FIG. 8 is a cross sectional view of rotor 20 in a motor 100D.

FIG. 9 is a perspective view of rotor 20 in a motor 200.

### DESCRIPTION OF EMBODIMENTS

Details of embodiments of the present disclosure will be described with reference to the drawings. In the drawings below, identical or corresponding parts will be designated by the same reference numerals, and overlapping description will not be repeated.

### First Embodiment

A motor according to a first embodiment will be described. The motor according to the first embodiment is referred to as a motor 100.

### Configuration of Motor 100

A configuration of motor 100 will be described below.

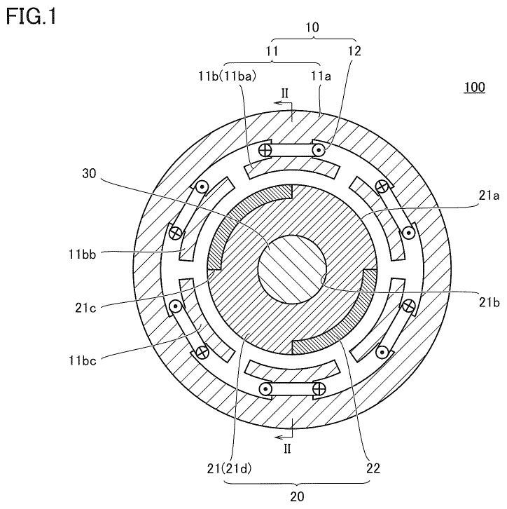

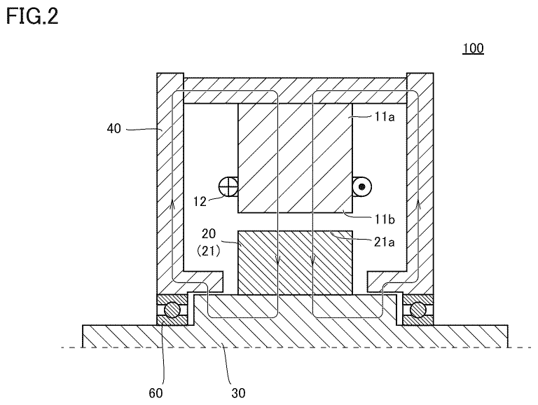

FIG. 1 is a cross sectional view of motor 100. FIG. 1 shows a cross section of motor 100 orthogonal to an axial direction. In FIG. 1, illustration of a case 40 is omitted. FIG. 2 is a cross sectional view taken along II-II in FIG. 1. As shown in FIGS. 1 and 2, motor 100 has a stator 10, a rotor 20, a shaft 30, and case 40, It should be noted that the axial direction is a direction of a central axis of shaft 30, and a radial direction is a direction which passes through the central axis of shaft 30 and which is orthogonal to the axial direction. Further, a circumferential direction is a direction of a circumference centered on the central axis of shaft 30.

Stator 10 has a stator core 11 and an armature winding 12. Stator core 11 is formed of a magnetic body. Stator core 11 has a core back 11a and a plurality of teeth 11b. Core back 11a is a ring extending along the circumferential direction. Teeth 11b protrude inward in the radial direction from an inner diameter surface of core back 11a. The plurality of teeth 11b are arranged with a spacing therebetween in the circumferential direction. Tooth 11b forming a U pole is referred to as a tooth 11ba . Tooth 11b forming a V pole is referred to as a tooth 11bb . Tooth 11b forming a W pole is referred to as a tooth 11bc. In the example shown in FIGS. 1 and 2, the number of teeth 11b is six.

The number of teeth 11ba , the number of teeth 11bb , and the number of teeth 11be are equal to one another. In the example shown in FIGS. 1 and 2, the number of teeth 11ba , the number of teeth 11bb , and the number of teeth 11be are two. Tooth 11ba , tooth 11bb , and tooth 11bc are arranged in this order in a counter-clockwise direction, for example.

Armature winding 12 is made of a conductive material. Armature winding 12 is made of copper or a copper alloy, for example. Armature winding 12 is wound around each of the plurality of teeth 11b. A portion of armature winding 12 wound around tooth 11ba is referred to as a winding portion 12a. A portion of armature winding 12 wound around tooth 11bb is referred to as a winding portion 12b. A portion of armature winding 12 wound around tooth 11bc is referred to as a winding portion 12c. A winding direction of winding portion 12a, a winding direction of winding portion 12b, and a winding direction of winding portion 12c are identical to one another.

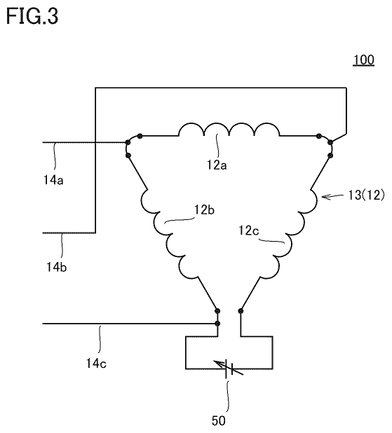

FIG. 3 is a schematic circuit diagram of motor 100. As shown in FIG. 3, winding portion 12a, winding portion 12b, and winding portion 12e constitute a ring connection 13. A DC power source 50 is connected to one end and the other end of ring connection 13. A direct current flows through ring connection 13 by DC power source 50 . The direct current flowing through ring connection 13 can be adjusted by DC power source 50. As described above, the winding direction of winding portion 12a, the winding direction of winding portion 12b, and the winding direction of winding portion 12c are identical to one another. Accordingly, by this direct current, tooth 11ba , tooth 11bb , and tooth 11be serve as magnetic poles with a polarity identical. to one another.

A connection line 14a is connected between winding portion 12a and winding portion 12b. A connection line 14b is connected between winding portion 12a and winding portion 12c. A connection line 14c is connected between winding portion 12b and DC power source 50. By connection line 14a, connection line 14b, and connection line 14c, a three-phase alternating current power source not shown is electrically connected to ring connection 13.

As shown in FIGS. 1 and 2, rotor 20 has a rotor core 21 and a plurality of permanent magnets 22. Rotor core 21 is formed of a magnetic body. Rotor core 21 has an outer diameter surface 21a and an inner diameter surface 21b. Outer diameter surface 21a and inner diameter surface 21b extend along the circumferential direction. Outer diameter surface 21a faces outward in the radial direction. Outer diameter surface 21a faces stator 10 (teeth 11b), with a gap being interposed therebetween, in the radial direction. Inner diameter surface 21b is a surface opposite to outer diameter surface 21a in the radial direction, That is, inner diameter surface 21b faces inward in the radial direction. A plurality of grooves 21c are formed in outer diameter surface 21a. The plurality of grooves 21c are arranged with a spacing therebetween along the circumferential direction. At grooves 21c, outer diameter surface 21a is recessed inward in the radial direction.

Rotor core 21 has a plurality of salient poles 21d in outer diameter surface 21a. A portion of rotor core 21 located between two adjacent grooves 21c serves as salient pole 21d. Accordingly, the plurality of salient poles 21d are arranged with a spacing therebetween along the circumferential direction. Since the number of grooves 21c is two in the example shown in FIGS. 1 and 2, the number of salient poles 21d is also two. Permanent magnet 22 is attached to outer diameter surface 21a. More specifically, permanent magnet 22 is attached to groove 21c. Accordingly, permanent magnet 22 is located between two salient poles 21d adjacent in the circumferential direction. Salient pole 21d forms a first magnetic pole by permanent magnet 22. Permanent magnet 22 forms a second magnetic pole. The first magnetic pole and the second magnetic pole are disposed alternately in the circumferential direction. The first magnetic pole and the second magnetic pole are an S pole and an N pole, respectively. Salient poles 21d and permanent magnets 22 face stator 10 (teeth 11b), with a cavity being interposed therebetween, in the radial direction.

Shaft 30 is formed of a magnetic body. Shaft 30 extends along the axial direction. Shaft 30 is attached to inner diameter surface 21b. Case 40 is formed of a magnetic body. Case 40 covers stator 10 and rotor 20. Shaft 30 is supported by a rolling bearing 60 attached to case 40, so as to be rotatable about the central axis of shaft 30.

In FIG. 3, a magnetic flux is indicated by solid arrows. In the example in FIG. 3, a magnetic flux directed inward in the radial direction from tooth 11b is generated. The magnetic flux generated in tooth 11b passes through a cavity between tooth 11b and outer diameter surface 21a, is interlinked with rotor 20, and is directed to shaft 30. This magnetic flux is divided into a magnetic flux directed to one side in the axial direction and a magnetic flux directed to the other side in the axial direction in shaft 30. The magnetic fluxes divided to one side and the other side in the axial direction pass through case 40 and core back 11a, and return to tooth 11b. It should be noted that, when a direct current flows through armature winding 12 in a reverse direction, the magnetic flux follows the path described above in a reverse direction.

### Effect of Motor 100

The effect of motor 100 will be described below.

When a magnetic flux directed outward in the radial direction is generated in tooth 11b, the magnetic flux serves as a magnetic flux with a direction which forms the S pole in salient pole 21d. Thereby, a magnetic flux of the S pole in salient pole 21d formed by permanent magnet 22 is strengthened, and as a result, magnetic flux density of a rotating magnetic field in the cavity between stator 10 and outer diameter surface 21a is increased. When the magnetic flux density of the rotating magnetic field in the cavity between stator 10 and outer diameter surface 21a is increased, torque of motor 100 is increased.

On the other hand, when a magnetic flux directed inward in the radial direction is generated in tooth 11b, the magnetic flux serves as a magnetic flux with a direction which forms the N pole in salient pole 21d. Thereby, the magnetic flux of the S pole in salient pole 21d formed by permanent magnet 22 is weakened, and as a result, the magnetic flux density of the rotating magnetic field in the cavity between stator 10 and outer diameter surface 21a is decreased. When the magnetic flux density of the rotating magnetic field in the cavity between stator 10 and outer diameter surface 21a is increased, voltage saturation during fast rotation can be suppressed, and thus a constant output operation range of motor 100 is expanded. Further, when the magnetic flux density of the rotating magnetic field in the cavity between stator 10 and outer diameter surface 21a is increased, iron loss during fast rotation and copper loss due to a field weakening current can be reduced.

In this way, according to motor 100, it is possible to change the magnetic flux density of the rotating magnetic field by controlling the direct current flowing through armature winding 12, and thus it is possible to expand an operable range without using a field winding. Further, since motor 100 does not require a field winding, an occupied volume ratio of armature winding 12 is improved, and a winding resistance can be reduced. Furthermore, since a winding process can be simplified in motor 100, manufacturability can also be improved.

### Second Embodiment.

A motor according to a second embodiment will be described. The motor according to the second embodiment is referred to as a motor 100A. Here, a difference from motor 100 will be mainly described, and overlapping description will not be repeated.

### Configuration of Motor 100A

A configuration of motor 100A will be described below.

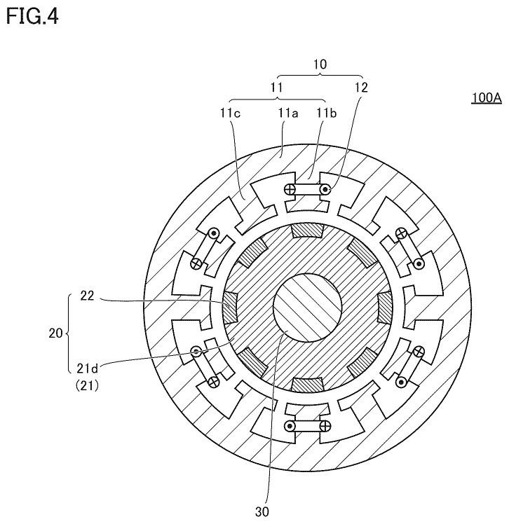

FIG. 4 is a cross sectional view of motor 100A. FIG. 4 shows a cross section of motor 100A orthogonal to the axial direction. As shown in FIG. 4, motor 100A has stator 10, rotor 20, shaft 30, and case 40 (not shown). In this regard, the configuration of motor 100A is common to the configuration of motor 100.

In motor 100A, stator core 11 has a plurality of teeth 11c. Each tooth 11c protrudes inward in the circumferential direction from the inner diameter surface of core back 11a. Tooth 11c is disposed between two adjacent teeth 11b. Armature winding 12 is not wound around each tooth 11c. From another viewpoint, a tooth around which armature winding 12 is wound and a tooth around which armature winding 12 is not wound are arranged alternately in the circumferential direction. In these regards, the configuration of motor 100A is different from the configuration of motor 100.

### Effect of Motor 100A

The effect of motor 100A will be described below.

In motor 100A, a magnetic flux is generated in tooth 11b when a direct current flows through armature winding 12. This magnetic flux passes through the cavity between stator 10 and outer diameter surface 21a and is interlinked with rotor 20. Further, this magnetic flux passes through the cavity between stator 10 and outer diameter surface 21a and is interlinked with tooth 11c, passes through core back 11a, and returns to tooth 11b. In the example shown in FIG. 4, the number of teeth 11b and the number of teeth 11b are six. Accordingly, in motor 100A, there is a fixed magnetic field with 12 poles (six pairs of poles) in the cavity between stator 10 and outer diameter surface 21a.

Further, in motor 100A, the number of salient poles 21d and the number of permanent magnets 22 are eight. Accordingly, in motor 100A, as rotor 20 rotates, the fixed magnetic field with six pairs of poles formed by DC magnetic fluxes is subjected to magnetic flux modulation by eight salient poles 21d, and a rotating magnetic field with four poles (two pairs of poles) is generated in the cavity between stator 10 and outer diameter surface 21a. In motor 100A, the rotating magnetic field in the cavity between stator 10 and outer diameter surface 21a synchronizes with a rotating magnetic field generated by a three-phase alternating current flowing through armature winding 12, to generate torque.

In motor 100A, when a magnetic flux directed inward in the radial direction is generated in tooth 11b by a direct current flowing through armature winding 12, torque due to a DC magnetic flux can be increased, in addition to torque generated by permanent magnet 22. Further, in motor 100A, when a magnetic flux directed outward in the radial direction is generated in tooth 11b by a direct current flowing through armature winding 12, voltage saturation during fast rotation can be alleviated by suppressing a back electromotive force.

In motor 100A, an armature magnetic flux causes the direct current to circulate within a plane orthogonal to the axial direction, without passing through shaft 30 and case 40. Accordingly, in motor 100A, there is no need to use shaft 30 and case 40 as a magnetic path, and weight reduction and downsizing can be achieved.

### Third Embodiment.

A motor according to a third embodiment will be described. The motor according to the third embodiment is referred to as a motor 100B. Here, a difference from motor 100 will be mainly described, and overlapping description will not be repeated.

### Configuration of Motor 100B

A configuration of motor 100B will be described below.

Motor 100B has stator 10, rotor 20, shaft 30, and case 40. In this regard, the configuration of motor 100B is common to the configuration of motor 100.

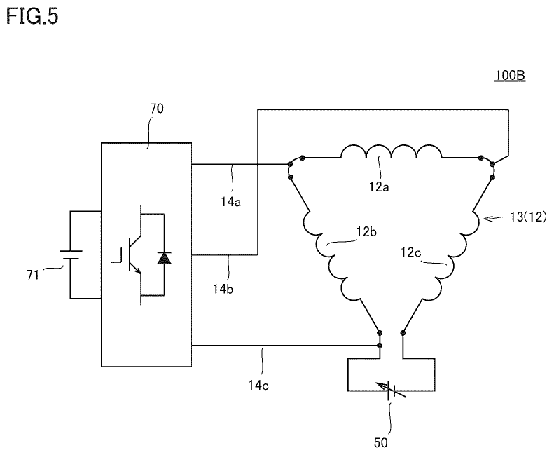

FIG. 5 is a schematic circuit diagram of motor 100B. As shown in FIG. 5, motor 100B further has an inverter 70 and a DC bus 71, Inverter 70 is driven by DC bus 71, and outputs a three-phase alternating current to armature winding 12 (ring connection 13) via connection line 14a, connection line 14b, and connection line 14c. A voltage of DC bus 71 is referred to as a first voltage. A voltage of DC power source 50 is referred to as a second voltage. The first voltage is set to be larger than the second voltage. In these regards, the configuration of motor 100B is different from the configuration of motor 100.

### Effect of Motor 100B

The effect of motor 100B will be described below.

When the first voltage is less than or equal to the second voltage, inverter 70 is energized by DC power source 50 via a diode included in inverter 70. As a result, in this case, it becomes impossible to supply the three-phase alternating current from inverter 70 to armature winding 12 (ring connection 13) via connection line 14a, connection line 14b, and connection line 14c. On the other hand, since the first voltage is larger than the second voltage in motor 100B, it is possible to prevent inverter 70 from being energized by DC power source 50, and it is possible to supply the three-phase alternating current from inverter 70 to armature winding 12 (ring connection 13) via connection line 14a, connection line 14b, and connection line 14c.

### Fourth Embodiment.

A motor according to a fourth embodiment will be described. The motor according to the fourth embodiment is referred to as a motor 100C. Here, a difference from motor 100 will be mainly described, and overlapping description will not be repeated.

### Configuration of Motor 100C

A configuration of motor 100C will be described below.

Motor 100C has stator 10, rotor 20, shaft 30, and case 40. In this regard, the configuration of motor 100C is common to the configuration of motor 100.

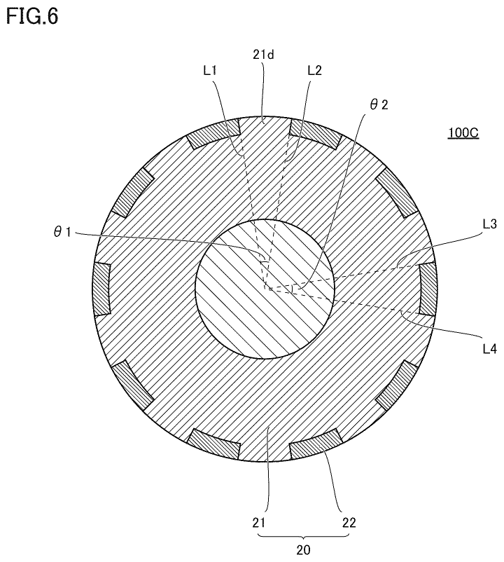

FIG. 6 is a cross sectional view showing one example of rotor 20 in motor 100C. As shown in FIG. 6, a virtual straight line passing through one end of salient pole 21d in the circumferential direction and a center of rotor core 21 is defined as a straight line L1, and a virtual straight line passing through the other end of salient pole 21d in the circumferential direction and the center of rotor core 21 is defined as a straight line L2. A virtual straight line passing through one end of permanent magnet 22 in the circumferential direction and the center of rotor core 21 is defined as a straight line L3, and a virtual straight line passing through the other end of permanent magnet 22 in the circumferential direction and the center of rotor core 21 is defined as a straight line L4.

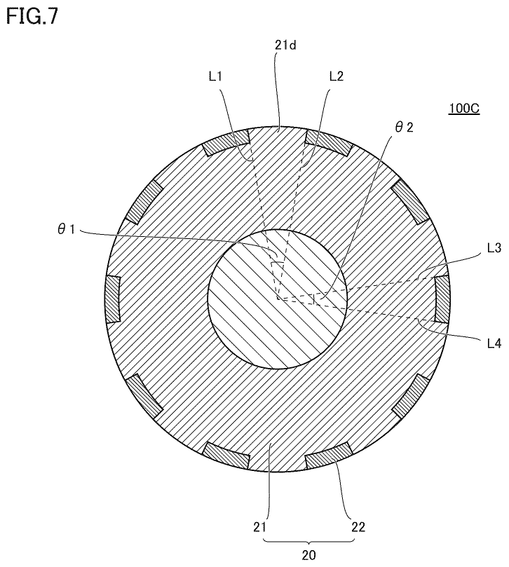

An angle formed between straight line L1 and straight line L2 is defined as an angle θ1, and an angle formed between straight line L3 and straight line L4 is defined as an angle θ2. In motor 100C, angle θ1 is equal to angle θ2. FIG. 7 is a cross sectional view showing another example of rotor 20 in motor 100C. As shown in FIG. 7, in motor 100C, angle θ1 may be different from angle θ2. In motor 100C, angle θ1 may be larger than angle θ2, or angle θ1 may be smaller than angle θ2. In these regards, the configuration of motor 100C is different from the configuration of motor 100.

### Effect of Motor 100C

The effect of motor 100C will be described below.

In motor 100C, an operation range can be adjusted by changing the ratio between angle θ1 and angle θ2. For example, a magnetic flux generated by permanent magnet 22 can be suppressed by setting angle θ1 to be larger than angle θ2, and the magnetic flux generated by permanent magnet 22 is increased by setting angle θ1 to be smaller than angle θ2. Further, as the relation in magnitude between angle θ1 and angle θ2 varies, the magnitude of a modulation wave also varies. By changing the ratio between angle θ1 and angle θ2 as described above, the magnetic flux generated by permanent magnet 22 or the magnitude of a modulation wave varies, and the operation range of motor 100C is adjusted.

### Fifth Embodiment.

A motor according to a fifth embodiment will be described. The motor according to the fifth embodiment is referred to as a motor 100D. Here, a difference from motor 100 will be mainly described, and overlapping description will not be repeated.

### Configuration of Motor 100D

A configuration of motor 100D will be described below.

Motor 100D has stator 10, rotor 20, shaft 30, and case 40. In this regard, the configuration of motor 100D is common to the configuration of motor 100.

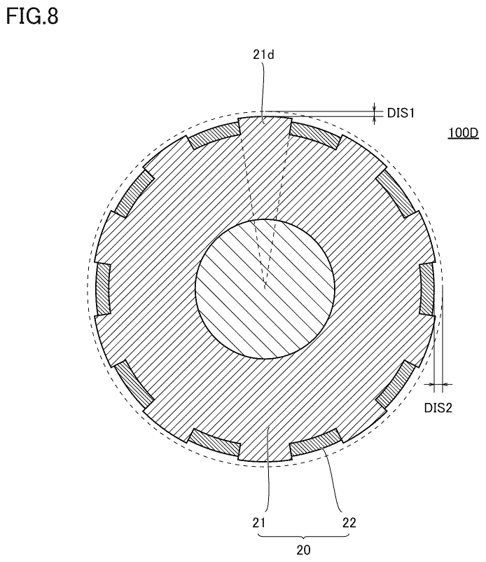

FIG. 8 is a cross sectional view of rotor 20 in motor 100D. In FIG. 8, positions of tips of teeth 11b in the radial direction are indicated by a dotted line. A minimum value of a distance between salient pole 21d and stator 10 in the radial direction is defined as a distance DIS1. A minimum value of a distance between permanent magnet 22 and stator 10 in the radial direction is defined as a distance DIS2. In motor 100D, distance DIS1 and distance DIS2 are different from each other. More specifically, in motor 100D, distance DIS1 may be larger than distance DIS2, or distance DIS1 may be smaller than distance DIS2. It should be noted that FIG. 8 shows an example where distance DIS1 is smaller than distance DIS2. In these regards, the configuration of motor 100D is different from the configuration of motor 100.

### Effect of Motor 100D

The effect of motor 100D will be described below.

In motor 100D, for example, by setting distance DIS1 to be smaller than distance DIS2, it is possible to reduce the amount by which a magnetic flux generated in tooth 11b is interlinked with permanent magnet 22, and it is possible to decrease eddy current loss generated in permanent magnet 22. Further, in this case, demagnetization resistance of permanent magnet 22 can be improved. Furthermore, in this case, it is possible to prevent permanent magnet 22 from being chipped due to contact between stator 10 and permanent magnet 22 during assembly or during driving. It should be noted that, if the two distances are approximately equal, a magnetic flux generated by permanent magnet 22 and a field magnetic flux generated by a field current are hardly reduced,

### Sixth Embodiment.

A motor according to a sixth embodiment will be described. The motor according to the fifth embodiment is referred to as a motor 200. Here, a difference from motor 100A will be mainly described, and overlapping description will not be repeated.

### Configuration of Motor 200

A configuration of motor 200 will be described below.

Motor 200 has stator 10, rotor 20, shaft 30, and case 40. In motor 200, stator 10 has stator core 11 including core back 11a, the plurality of teeth 11b, and the plurality of teeth 11c, and armature winding 12 wound around each of the plurality of teeth 11b. In these regards, the configuration of motor 200 is common to the configuration of motor 100A.

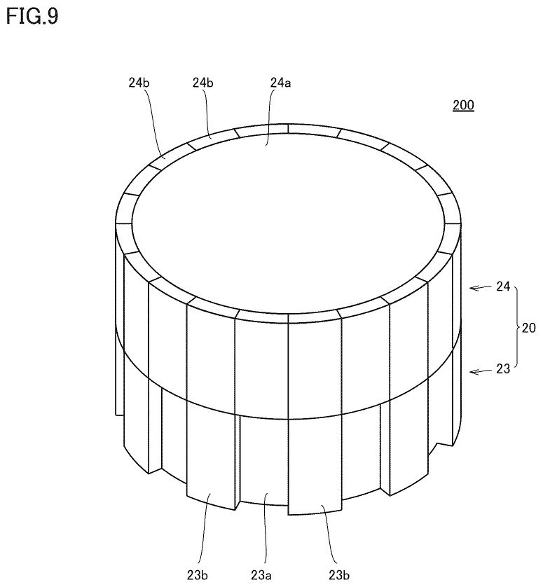

FIG. 9 is a perspective view of rotor 20 in motor 200. As shown in FIG. 9, in motor 200, rotor 20 has a first rotor unit 23 and a second rotor unit 24. First rotor unit 23 and second rotor unit 24 are arranged along the axial direction. First rotor unit 23 is constituted by a rotor core 23a. In an outer diameter surface of rotor core 23a, a plurality of salient poles 23b are formed with a spacing therebetween along the circumferential direction. Second rotor unit 24 has a rotor core 24a and a plurality of permanent magnets 24b. The plurality of permanent magnets 24b are attached to an outer circumferential surface of rotor core 24a so as to be arranged along the circumferential direction. In these regards, the configuration of motor 200 is common to the configuration of motor 100A. It should be noted that, although rotor 20 is constituted by two rotor units in this example, the number of rotor units in rotor 20 may be three or more.

### Effect of Motor 200

The effect of motor 200 will be described below.

In motor 200, since stator 10 has stator core 11 including core back 11a, the plurality of teeth 11b, and the plurality of teeth 11c, and armature winding 12 wound around each of the plurality of teeth 11b, as in motor 100A, torque can be generated in second rotor unit 24. Further, in motor 200, torque generated in first rotor unit 23 can be adjusted by controlling a direct current flowing through armature winding 12 by DC power source 50.

It should be understood that the embodiments disclosed herein are illustrative and non-restrictive in every respect. The basic scope of the present disclosure is defined by the scope of the claims, rather than the embodiments described above, and is intended to include any modifications within the scope and meaning equivalent to the. scope of the claims.

### REFERENCE SIGNS LIST

100, 100A, 100B, 100C, 100D, 200: motor; 10: stator; 11: stator core; 11a: core back; 11b, 11ba , 11bb , 11bc, 11c: tooth; 12: armature winding; 12a, 12b, 12c: winding portion; 13: ring connection; 14a, 14b, 14c: connection line; 20: rotor; 21: rotor core; 21a: outer diameter surface; 21b: inner diameter surface; 21c: groove; 21d: salient pole; 22: permanent magnet; 23: first rotor unit; 23a: rotor core; 23b: salient pole; 24: second rotor unit; 24a: rotor core; 24b: permanent magnet; 30: shaft; 40: case; 50: DC power source; 60: rolling bearing; 70: inverter; 71: DC bus; DIS1, DIS2: distance; L1, L2, L3, L4: straight line.

1. A motor comprising:
a stator; and
a rotor, wherein
the stator has a plurality of first teeth disposed with a spacing therebetween in a circumferential direction, and an armature winding wound around each of the plurality of first teeth,
the armature winding is a ring connection,
a DC power source is connected to one end and another end of the ring connection,
in each of the plurality of first teeth, a magnetic pole with an identical polarity is formed by a direct current flowing through the armature winding,
the rotor has a rotor core and a plurality of permanent magnets,
the rotor core has an outer diameter surface facing outward in a radial direction, and an inner diameter surface which is a surface opposite to the outer diameter surface in the radial direction,
the rotor core has a plurality of salient poles forming first magnetic poles in the outer diameter surface,
the plurality of salient poles are arranged with a spacing therebetween along the circumferential direction,
each of the plurality of permanent magnets is attached to the outer diameter surface so as to be located between two adjacent salient poles of the plurality of salient poles in the circumferential direction, and forms a second magnetic pole, and
the plurality of salient poles and the plurality of permanent magnets face the stator, with a cavity being interposed therebetween, in the radial direction.

2. The motor according to claim 1, wherein a winding direction of the armature winding is identical in each of the plurality of first teeth.

3. The motor according to claim 1, further comprising:
a shaft; and
a case, wherein
the shaft and the case are each formed of a magnetic body,
the shaft is attached to the inner diameter surface,
the case covers the stator and the rotor, and
a magnetic flux generated in each of the plurality of first teeth, by the direct current flowing through the armature winding, passes through the cavity, each of the plurality of salient poles, the shaft, and the case, and returns to each of the plurality of first teeth.

4. The motor according to claim 1, wherein
the stator further has a plurality of second teeth disposed with a spacing therebetween in the circumferential direction, and
each of the plurality of second teeth is disposed between two adjacent first teeth of the plurality of first teeth.

5. The motor according to claim 1, wherein a minimum value of a distance between each of the plurality of permanent magnets and the stator is different from a minimum value of a distance between each of the plurality of salient poles and the stator.

6. The motor according to claim 1, wherein
each of the plurality of permanent magnets has a first end and a second end in the circumferential direction,
each of the plurality of salient poles has a third end and a fourth end in the circumferential direction, and
a first angle formed between a first virtual straight line passing through the first end and a center of the rotor core and a second virtual straight line passing through the second end and the center is different from a second angle formed between a third virtual straight line passing through the third end and the center and a fourth virtual straight line passing through the fourth end and the center.

7. The motor according to claim 1, further comprising a power converter electrically connected to the armature winding, wherein
the power converter is driven by a DC bus, and
a voltage of the DC bus is larger than a voltage of the DC power source.

8. A motor comprising:
a stator; and
a rotor disposed with a cavity being interposed between the rotor and the stator in a radial direction, wherein
the stator has a plurality of teeth disposed with a spacing therebetween in a circumferential direction, and an armature winding wound around each of the plurality of teeth,
the armature winding is a ring connection,
a DC power source is connected to one end and another end of the ring connection,
in each of the plurality of teeth, a magnetic pole with an identical polarity is formed by a direct current flowing through the armature winding,
the rotor has a first rotor unit and a second rotor unit,
the first rotor unit and the second rotor unit are arranged along an axial direction,
a field pole of the first rotor unit is constituted by a salient pole only, and
a field pole of the second rotor unit is constituted by a permanent magnet only.

9. The motor according to claim 2, wherein a minimum value of a distance between each of the plurality of permanent magnets and the stator is different from a minimum value of a distance between each of the plurality of salient poles and the stator.

10. The motor according to claim 3, wherein a minimum value of a distance between each of the plurality of permanent magnets and the stator is different from a minimum value of a distance between each of the plurality of salient poles and the stator.

11. The motor according to claim 4, wherein a minimum value of a distance between each of the plurality of permanent magnets and the stator is different from a minimum value of a distance between each of the plurality of salient poles and the stator.

12. The motor according to claim 2, wherein
each of the plurality of permanent magnets has a first end and a second end in the circumferential direction,
each of the plurality of salient poles has a third end and a fourth end in the circumferential direction, and
a first angle formed between a first virtual straight line passing through the first end and a center of the rotor core and a second virtual straight line passing through the second end and the center is different from a second angle formed between a third virtual straight line passing through the third end and the center and a fourth virtual straight line passing through the fourth end and the center.

13. The motor according to claim 3, wherein
each of the plurality of permanent magnets has a first end and a second end in the circumferential direction,
each of the plurality of salient poles has a third end and a fourth end in the circumferential direction, and
a first angle formed between a first virtual straight line passing through the first end and a center of the rotor core and a second virtual straight line passing through the second end and the center is different from a second angle formed between a third virtual straight line passing through the third end and the center and a fourth virtual straight line passing through the fourth end and the center.

14. The motor according to claim 4, wherein
each of the plurality of permanent magnets has a first end and a second end in the circumferential direction,
each of the plurality of salient poles has a third end and a fourth end in the circumferential direction, and
a first angle formed between a first virtual straight line passing through the first end and a center of the rotor core and a second virtual straight line passing through the second end and the center is different from a second angle formed between a third virtual straight line passing through the third end and the center and a fourth virtual straight line passing through the fourth end and the center.

15. The motor according to claim 2, further comprising a power converter electrically connected to the armature winding, wherein
the power converter is driven by a DC bus, and
a voltage of the DC bus is larger than a voltage of the DC power source.

16. The motor according to claim 3, further comprising a power converter electrically connected to the armature winding, wherein
the power converter is driven by a DC bus, and
a voltage of the DC bus is larger than a voltage of the DC power source.

17. The motor according to claim 4, further comprising a power converter electrically connected to the armature winding, wherein
the power converter is driven by a DC bus, and
a voltage of the DC bus is larger than a voltage of the DC power source.
